(19) United States
(12) Patent Application Publication
(10) Pub. No.: US 2026/0330878 A1
(43) Pub. Date: Oct. 22, 2026

(54) METHOD AND APPARATUS FOR DETERMINING FACE IMAGE SPOOFING

(71) Applicant: RESEARCH & BUSINESS FOUNDATION SUNGKYUNKWAN UNIVERSITY, Suwon-si (KR)

(72) Inventors: Minh Binh Le, Suwon-si (KR); Simon Sungil Woo, Suwon-si (KR)

(21) Appl. No.: 19/468,716

(22) Filed: Feb. 3, 2026

(30) Foreign Application Priority Data
Feb. 7, 2025 (KR) 10-2025-0015798

(51) Int. Cl. G06V 40/40; G06V 10/776; G06V 10/82

(52) U.S. Cl. CPC G06V 40/40; G06V 10/776; G06V 10/82

(57) ABSTRACT

The present disclosure relates to a technology for detecting spoofing of face images, and more specifically, to a technology capable of exhibiting consistent face image spoofing detection performance even for a plurality of heterogeneous training spoofing domains. According to an aspect of the present disclosure, a face image spoofing determination method performed by an apparatus for determining whether a face image is spoofed, the method comprising: receiving a target face image; determining whether the target face image is spoofed using a pre-trained heterogeneous domain spoofing detection model; and outputting a result of the determining of whether the target face image is spoofed.

### CROSS-REFERENCE TO RELATED APPLICATION

This application claims the benefit of Korean Patent Application No. 10-2025-0015798, filed on Feb. 7, 2025, in the Korean Intellectual Property Office, the disclosure of which is incorporated herein by reference in its entirety.

### TECHNICAL FIELD

The present disclosure relates to a technology for detecting spoofing of face image, and more specifically, to a technology capable of exhibiting consistent face image spoofing detection performance even for a plurality of heterogeneous training spoofing domains.

### BACKGROUND OF THE INVENTION

Existing initial face spoofing detection and prevention research mainly included methods identifying facial features through hand-crafted features or utilizing biometric features such as eye blinking, lip movement, and head movement. However, with the advancement of deep learning technology, deep neural networks were introduced, and performance was greatly improved by using depth maps, reflection maps, and supervision signals. Recently, transformer-based architectures have been introduced and are showing good results in detecting spoofing attempts.

Although Domain Adaptation (DA) and Domain Generalization (DG) technologies have advanced due to the need for heterogeneous domain generalization in models, existing research has a problem of relying on auxiliary modules to filter domain-specific features and still lacks generalization performance for new domains.

That is, although conventional techniques relied on an auxiliary module to separate domain-specific attributes and maintain general domain attributes, there was a limitation in consistently maintaining domain attributes or completely removing domain-specific features in various face images.

### SUMMARY OF THE INVENTION

Embodiments provide a Face Anti-Spoofing technology maintaining consistent performance across various domains by developing a methodology capable of more efficiently aligning and generalizing the inter-domain responses of a model in heterogeneous face domains.

Embodiments also provide a learning method, as a new algorithm (GAC-FAS: Gradient Alignment for Cross-Domain Face Anti-Spoofing) for Face Anti-Spoofing (FAS) technology in various heterogeneous cross-domains, guiding a model to reach an optimized minimum point without additional learning modules, thereby significantly improving the generalization performance of the model.

Furthermore, embodiments adopt a method of adjusting a gradient through Empirical Risk Minimization (ERM) with a generalized Gradient Update by utilizing ascent points within each domain from various face data. This enhances the robustness of the model against domain changes and harmonizes with existing risk minimization principles.

Embodiments further provide a technology capable of overcoming the limitations of existing techniques achieving generalization from a single Source Domain while effectively handling various types of noise, by applying a Sharpness Aware Minimization technique to multi-source Domain Generalization (DG) in Face Anti-Spoofing (FAS).

Furthermore, embodiments enable generalization gradient updates derived from multiple sources to be harmoniously aligned with each other and also to match a gradient update of Empirical Risk Minimization (ERM) by customizing a Sharpness Aware Minimization technique for a multi-source domain environment of heterogeneous face data.

Another object of the present invention is to enable utilization of the potential of a sharpness-aware minimization technique for domain generalization in face anti-spoofing.

According to an aspect of the present disclosure, excellent generalization ability is exhibited in the task of Face Anti-Spoofing (FAS) in heterogeneous multi-domains through a gradient alignment technique and sharpness-aware minimization.

In accordance with an aspect of the present disclosure, there is provided a face image spoofing determination method performed by an apparatus for determining whether a face image is spoofed, the method comprising: receiving a target face image; determining whether the target face image is spoofed using a pre-trained heterogeneous domain spoofing detection model; and outputting a result of the determining of whether the target face image is spoofed; wherein the heterogeneous domain spoofing detection model calculates respective loss gradients based on a loss function of each of a plurality of training face image domains, calculates a total loss gradient of the plurality of training face image domains based on the respective loss gradients, calculates a plurality of perturbation losses based on the respective loss gradients and the total loss gradient, and is pre-trained based on the plurality of perturbation losses so that an empirical risk is minimized.

The heterogeneous domain spoofing detection model comprises an artificial neural network generated by updating a gradient such that the empirical risk is minimized.

The heterogeneous domain spoofing detection model is generated by performing minimization of the empirical risk based on a gradient ascent point within the plurality of training face image domains for the plurality of perturbation losses, and updating the artificial neural network based on a result of performing the minimization of the empirical risk for the plurality of perturbation losses.

In accordance with an aspect of the present disclosure, there is provided a learning method for training a heterogeneous domain spoofing detection model, performed by a computing device to determine whether a face image is spoofed, the method comprising: (a) calculating respective loss gradients based on a loss function of each of a plurality of training face image domains; (b) calculating a total loss gradient of the plurality of training face image domains based on the respective loss gradients; (c) calculating a plurality of perturbation losses based on the respective loss gradients and the total loss gradient; and (d) training the heterogeneous domain spoofing detection model based on the plurality of perturbation losses such that an empirical risk is minimized.

The method further comprising repeatedly performing operations (a) to (d) until a gradient of the heterogeneous domain spoofing detection model reaches a predefined flat minimum.

The operation (d) comprises: performing minimization of the empirical risk based on a gradient ascent point within each training face image domain for the plurality of perturbation losses; and updating the heterogeneous domain spoofing detection model based on a result of performing the minimization of the empirical risk for the plurality of perturbation losses.

In accordance with an aspect of the present disclosure, there is provided an apparatus for determining whether a face image is spoofed, comprising: a memory storing a face image spoofing determination program including one or more instructions; and a processor that loads the face image spoofing determination program from the memory and executes the face image spoofing determination program, wherein the one or more instructions, when executed by the processor, cause the processor to: receive a target face image, and determine whether the target face image is spoofed using a pre-trained heterogeneous domain spoofing detection model, and wherein the heterogeneous domain spoofing detection model is pre-trained to (a) calculate respective loss gradients based on a loss function of each of a plurality of training face image domains, (b) calculate a total loss gradient of the plurality of training face image domains based on the respective loss gradients, (c) calculate a plurality of perturbation losses based on the respective loss gradients and the total loss gradient, and (d) minimize an empirical risk based on the plurality of perturbation losses.

The heterogeneous domain spoofing detection model comprises an artificial neural network model generated by updating a gradient such that the empirical risk is minimized.

The heterogeneous domain spoofing detection model is generated by performing minimization of the empirical risk based on a gradient ascent point within the plurality of training face image domains for the plurality of perturbation losses, and updating the artificial neural network model based on a result of performing the minimization of the empirical risk for the plurality of perturbation losses.

The processor is configured to repeatedly perform operations (a) to (d) until a gradient of the heterogeneous domain spoofing detection model reaches a predefined flat minimum.

### BRIEF DESCRIPTION OF THE DRAWINGS

FIG. 1 is a block diagram of an apparatus for determining whether a face image is spoofed according to an embodiment of the present disclosure.

FIG. 2 is a flowchart of a method for determining whether a face image is spoofed according to an embodiment of the present disclosure.

FIG. 3 is a flowchart of a method of training a heterogeneous domain spoofing detection model to determine whether a face image is spoofed according to an embodiment of the present disclosure.

FIG. 4 is a diagram illustrating an example of an entire algorithm operation pipeline in the method of training the heterogeneous domain spoofing detection model of FIG. 3.

FIG. 5 is a block diagram of an apparatus for determining whether a face image is spoofed according to another embodiment of the present disclosure.

### DETAILED DESCRIPTION OF THE INVENTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

Hereinafter, embodiments of the present disclosure will be described in detail with reference to the attached drawings.

The present disclosure relates to a new FAS technology aiming for a new optimization learning method to achieve an optimal flat minimum, i.e., a domain-generalizable gradient flat minimum, in heterogeneous domain Face Anti-Spoofing (FAS), thereby improving the model's generalization ability without an additional module such as an auxiliary device.

In the present disclosure, an input space X∈R^{d} and an output space Y=0 (fake or spoo fed), 1(real) are considered, and the present disclosure assumes that k different source domains

$$S = \text{?}$$

$$\text{?} \text{indicates text missing or illegible when filed}$$

and one target domain T are given. A neural network f: X→Y aims to distinguish whether an input x is real or spoofed in a source domain through learning parameters θ Given K training domains, the loss minimization formula using the ERM framework in the conventional standard optimal generalization learning method is as follows:

min_{θ}L(θ;S)=min_{θ}E_{S}_{ᵢ}_{-z}L(θ;Sᵢ)

The empirical loss equation in the i-th domain is as follows:

L(θ;Sᵢ)=E_{(x,y)~z} [symbol] (f(x;θ),y)

[symbol] may be a cross-entropy loss or a regression loss L₁. To minimize the empirical risk L(θ;S), the neural network f attempts to identify an optimal set of parameters θ*.

However, a major problem of ERM is susceptibility to overfitting to training data, which may lead to performance degradation in unforeseen domains. In particular, in face authentication, domain-specific attributes such as camera settings and face image resolution may exacerbate the problem. Therefore, aiming for flat gradient minimization not biased towards a specific domain when training on source domains is important for effectively solving the domain generalization problem of FAS.

The present disclosure proposes the following two important conditions and techniques to ensure that the model maintains robustness and generalization performance even on unseen face data domains.

1. Optimization of the minimum: The identified minimum should be sufficiently low and lie on a flat surface of the loss function. This aligns with the main objective of achieving optimization of the minimum of the loss landscape on the training set.

2. Inter-domain gradient alignment: A generalization gradient update learned from any domain in a face image source training dataset should be aligned with the risk minimization (ERM) gradient of other domains. This condition achieves harmony in optimization, reduces potential conflicts, and allows Lᵥ(θ;S) to compensate for domain changes in FAS.

To satisfy these conditions, the present disclosure proposes the following new optimization objective:

L(θ;S)+E_{S}_{ᵢ}_{-S}Lᵥ(θ−γ∇L(θlS);S)+R(θ;S)

With this formula, the model may be perturbed for each domain and the gradient term γ∇L(θlS) of the auxiliary ERM may be simultaneously learned for all training source domains. Since the optimal perturbation noise is expressed by

$${\hat{ϵ}}_{i} = ρ \frac{∇ L ( θ lS ) ; S )}{‖ ∇ L ( θ lS ) ; S ) ‖} ,$$

maintaining excellent anti-spoofing (FAS) performance in heterogeneous domains is enabled by developing it into the following final learning formula.

L(θ;S)+E_{S}_{ᵢ}_{-S}Lᵥ(θ+\hat{ϵ}ᵢ−γ∇L(θlS);S)+R(θ;S)

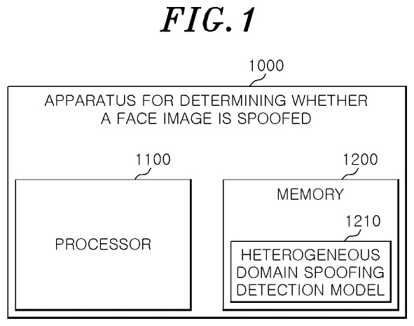

FIG. 1 is a block diagram of a face image spoofing determination apparatus according to an embodiment of the present disclosure.

Referring to FIG. 1, a face image spoofing determination apparatus 1000 according to an exemplary embodiment of the present disclosure may include a processor 1100 and a memory 1200.

The processor 1100 may control the overall operation of the face image spoofing determination apparatus 1000. Specifically, the processor 1100 may perform a face image spoofing determination method and training for a heterogeneous domain spoofing detection model 1210 by executing instructions stored in the memory 1200.

The memory 1200 may store instructions for performing the overall operation of the face image spoofing determination apparatus 1000. Specifically, the memory 1200 may store instructions for performing a face image spoofing determination method, training for a heterogeneous domain spoofing detection model 1210, and the like.

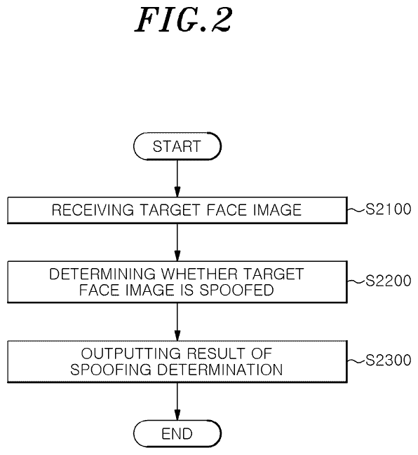

Hereinafter, the specific operation of the face image spoofing determination apparatus 1000 will be described with reference to FIGS. 2 to 4.

FIG. 2 is a flowchart of a face image spoofing determination method according to an embodiment of the present disclosure.

Hereinafter, the method will be described as being performed by the face image spoofing determination apparatus 1000 shown in FIG. 1 as an example.

In operation S2100, the face image spoofing determination apparatus 1000 may receive a target face image serving as an object for determination of whether the target face image is spoofed.

In operation S2200, the face image spoofing determination apparatus 1000 may determine whether a target face image is spoofed using a pre-trained heterogeneous domain spoofing detection model 1210.

In an embodiment, the heterogeneous domain spoofing detection model 1210 may be generated by modifying an artificial neural network-based classification model by applying ERM to K perturbation losses calculated based on a total gradient of K training face image domains and loss gradients being gradients of a loss function for each training face image domain.

In an embodiment, the face image spoofing determination apparatus 1000 may acquire the pre-trained heterogeneous domain spoofing detection model 1210 from an external device (not shown).

In an embodiment, the face image spoofing determination apparatus 1000 may generate the heterogeneous domain spoofing detection model 1210 by modifying the artificial neural network-based classification model by applying ERM to K perturbation losses calculated based on a total gradient of K training face image domains and loss gradients being gradients of a loss function for each training face image domain.

In operation S2300, the face image spoofing determination apparatus 1000 may output a result of the determination of whether the target face image is spoofed.

In an embodiment, the face image spoofing determination apparatus 1000 may transmit the result of the spoofing determination for the target face image to an external device (not shown) using wired or wireless data communication.

In an embodiment, the face image spoofing determination apparatus 1000 may output the result of the spoofing determination for the target face image through a device such as a display so that a user may recognize the result.

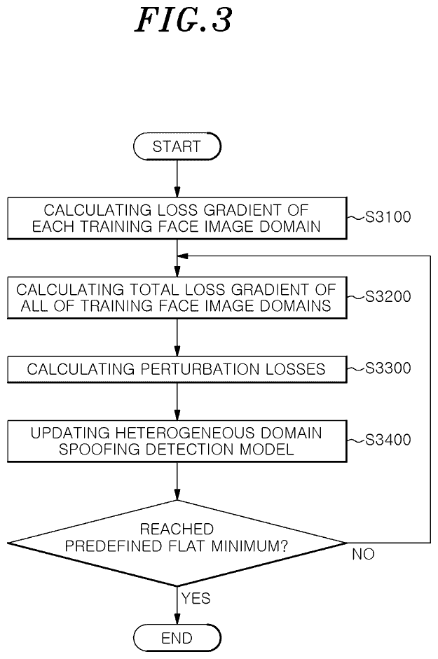

FIG. 3 is a flowchart of a method of training a heterogeneous domain spoofing detection model 1210 according to an embodiment of the present disclosure.

Hereinafter, the method maybe performed by the face image spoofing determination apparatus 1000 for determining whether a face image is spoofed, as illustrated in FIG. 1, and may also be performed by a separate computing device.

In operation S3100, the face image spoofing determination apparatus 1000 may calculate a loss gradient, which is a gradient of a loss function for each of K training face image domains, using an artificial neural network-based classification model.

In operation S3200, the face image spoofing determination apparatus 1000 may calculate a total gradient for the K training face image domains.

In operation S3300, the face image spoofing determination apparatus 1000 may calculate K perturbation losses based on the loss gradients corresponding to the gradients of the loss function for each of the K training face image domains, and the total gradient.

In operation S3400, the face image spoofing determination apparatus 1000 may update the artificial neural network-based classification model based on the K perturbation losses. Through this update, a generalized and robust classification model may be generated.

In an embodiment, the face image spoofing determination apparatus 1000 may update the artificial neural network-based classification model based on the K perturbation losses, perform minimization of empirical risk based on a gradient ascent point within each face image domain for the K perturbation losses, and update the artificial neural network-based classification model based on a result of performing the minimization of empirical risk for the K perturbation losses.

In operation S3500, the face image spoofing determination apparatus 1000 may determine whether a gradient of the artificial neural network-based classification model has reached a predefined flat minimum.

In an embodiment, if a gradient of the artificial neural network-based classification model has not reached a predefined flat minimum, the face image spoofing determination apparatus 1000 may repeatedly perform operations S3100 to S3400 until the predefined flat minimum is reached.

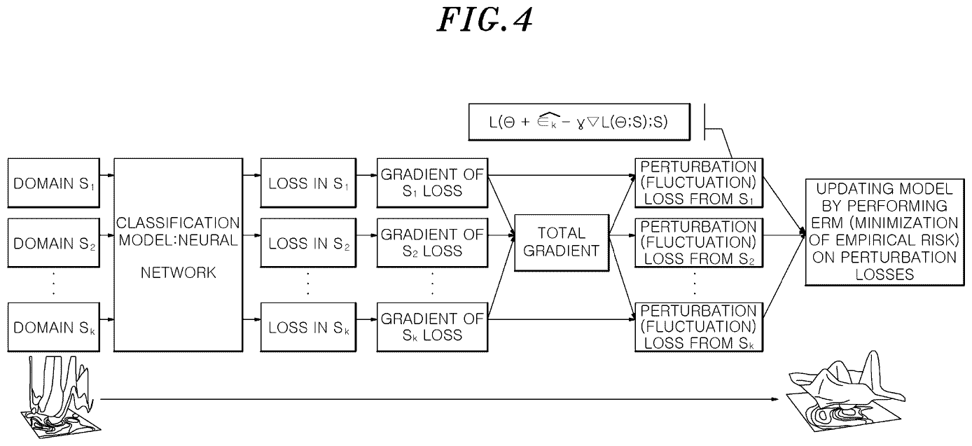

FIG. 4 is a diagram for explaining an example in which the face image spoofing determination apparatus 1000 or computing device according to an embodiment of the present disclosure trains a heterogeneous domain spoofing detection model 1210.

Referring to FIG. 4, an entire algorithm operation pipeline representing a training process of a heterogeneous domain spoofing detection model 1210 according to an embodiment of the present disclosure is shown. That is, this diagrammatically illustrates a process of performing generalized training suitable for a plurality of heterogeneous domains in Face-Anti Spoofing (FAS). The process has a learning objective of guiding the model to reach an optimal flat minimum without additional learning modules. For this, the gradient was adjusted using the ERM technique, which minimizes error risk, by utilizing gradient ascent points within each domain. Finally, a generalized model is output along with convergence of the optimized generalization loss function and optimization of the perturbation.

The diagram illustrates a detailed algorithm for calculating a gradient. First, the loss and its gradient in each domain requesting generalization learning are calculated. The total gradient calculated based on each gradient and the perturbation of each domain ultimately allow the perturbation loss from each domain to be calculated. ERM (minimization of error risk) learning is performed using the perturbation losses extracted for the requested training dataset, and generalized learning that converges to a minimum of the flattened loss is performed.

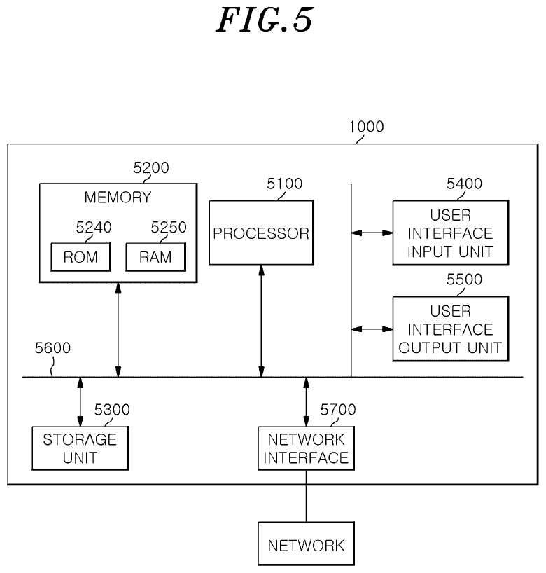

FIG. 5 is a block diagram of a computing device for determining whether a face image is spoofed or for training an artificial neural network to determine whether a face image is spoofed, according to another embodiment of the present invention.

As shown in FIG. 5, the computing device 1000 may include at least one or more elements among a processor 5100, a memory 5200, a storage unit 5300, a user interface input unit 5400, and a user interface output unit 5500, and these may communicate with each other via a bus 5600. Furthermore, the computing device 1000 may also include a network interface 5700 for connecting to a network. Abase station 3000 and a terminal 4000 included in a wireless communication system 2000 may be a CPU or a semiconductor device executing processing instructions stored in the memory 5200 and/or the storage 5300. The memory 5200 and the storage unit 5300 may include various types of volatile/non-volatile storage media. For example, the memory may include a ROM 5240 and a RAM 5250.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A face image spoofing determination method performed by an apparatus for determining whether a face image is spoofed, the method comprising:
receiving a target face image;
determining whether the target face image is spoofed using a pre-trained heterogeneous domain spoofing detection model; and
outputting a result of the determining of whether the target face image is spoofed;
wherein the heterogeneous domain spoofing detection model calculates respective loss gradients based on a loss function of each of a plurality of training face image domains, calculates a total loss gradient of the plurality of training face image domains based on the respective loss gradients, calculates a plurality of perturbation losses based on the respective loss gradients and the total loss gradient, and is pre-trained based on the plurality of perturbation losses so that an empirical risk is minimized.

2. The method of claim 1, wherein the heterogeneous domain spoofing detection model comprises an artificial neural network generated by updating a gradient such that the empirical risk is minimized.

3. The method of claim 2, wherein the heterogeneous domain spoofing detection model is generated by performing minimization of the empirical risk based on a gradient ascent point within the plurality of training face image domains for the plurality of perturbation losses, and updating the artificial neural network based on a result of performing the minimization of the empirical risk for the plurality of perturbation losses.

4. A learning method for training a heterogeneous domain spoofing detection model, performed by a computing device to determine whether a face image is spoofed, the method comprising:
(a) calculating respective loss gradients based on a loss function of each of a plurality of training face image domains;
(b) calculating a total loss gradient of the plurality of training face image domains based on the respective loss gradients;
(c) calculating a plurality of perturbation losses based on the respective loss gradients and the total loss gradient; and
(d) training the heterogeneous domain spoofing detection model based on the plurality of perturbation losses such that an empirical risk is minimized.

5. The method of claim 4, further comprising repeatedly performing operations (a) to (d) until a gradient of the heterogeneous domain spoofing detection model reaches a predefined flat minimum.

6. The method of claim 4, wherein operation (d) comprises:
performing minimization of the empirical risk based on a gradient ascent point within each training face image domain for the plurality of perturbation losses; and
updating the heterogeneous domain spoofing detection model based on a result of performing the minimization of the empirical risk for the plurality of perturbation losses.

7. An apparatus for determining whether a face image is spoofed, comprising:
a memory storing a face image spoofing determination program including one or more instructions; and
a processor that loads the face image spoofing determination program from the memory and executes the face image spoofing determination program,
wherein the one or more instructions, when executed by the processor, cause the processor to:
receive a target face image, and determine whether the target face image is spoofed using a pre-trained heterogeneous domain spoofing detection model, and
wherein the heterogeneous domain spoofing detection model is pre-trained to (a) calculate respective loss gradients based on a loss function of each of a plurality of training face image domains, (b) calculate a total loss gradient of the plurality of training face image domains based on the respective loss gradients, (c) calculate a plurality of perturbation losses based on the respective loss gradients and the total loss gradient, and (d) minimize an empirical risk based on the plurality of perturbation losses.

8. The apparatus of claim 7, wherein the heterogeneous domain spoofing detection model comprises an artificial neural network model generated by updating a gradient such that the empirical risk is minimized.

9. The apparatus of claim 8, wherein the heterogeneous domain spoofing detection model is generated by performing minimization of the empirical risk based on a gradient ascent point within the plurality of training face image domains for the plurality of perturbation losses, and updating the artificial neural network model based on a result of performing the minimization of the empirical risk for the plurality of perturbation losses.

10. The apparatus of claim 7, wherein the processor is configured to repeatedly perform operations (a) to (d) until a gradient of the heterogeneous domain spoofing detection model reaches a predefined flat minimum.
